(19) United States
(12) Patent Application Publication
(10) Pub. No.: US 2015/0199647 A1
(43) Pub. Date: Jul. 16, 2015

(54) SYSTEM AND METHOD FOR PROVIDING VISUAL JOB INFORMATION AND JOB SEEKER'S INFORMATION

(71) Applicant: Job Search Television Network, Geneva, IL (US)

(72) Inventors: Young Jea Shin, Plainfield, IL (US); Roger John Stanton, Geneva, IL (US); Lindsay Stanton, Geneva, IL (US)

(73) Assignee: Job Search Television Network, Geneva, IL (US)

(21) Appl. No.: 14/656,277

(22) Filed: Mar. 12, 2015

Related U.S. Application Data
(63) Continuation-in-part of application No. 13/551,404, filed on Jul. 17, 2012.
Application No. 13/551,404 is a continuation-in-part of application No. 13/071,610, filed on Mar. 25, 2011.
(60) Provisional application No. 61/317,354, filed on Mar. 25, 2010.

(51) Int. Cl. G06Q 10/10

(52) U.S. Cl. CPC G06Q 10/1053

(57) ABSTRACT

The present disclosure relates to an automated process and associated computerized system for improving the recruitment process of qualified candidates for opened positions of different job postings, the process and system includes a platform for transforming information into a video posting displaying human and written video highlights based on the information, and more particularly to an online platform which includes multiple different functions, which includes uploading a text job opening and receiving a encoded video to imbed in internet sites where job seekers can access the posting, offering a more cost efficient alternative for a semi-manual job reports generation, and the automated process of generating a post-response candidate expectation video and support information.

### RELATED APPLICATIONS

This application claims priority to, and the benefit of, U.S. Provisional Application Ser. No. 61/317,354, filed Mar. 25, 2010, for all subject matter common to both applications, and claims priority to, and the benefit of, U.S. Non-Provisional Application Ser. No. 13/071,610, filed Mar. 25, 2011 also entitled System and Method for Providing Visual Job Information and Job Seeker's Information, naming Young Jea Shin as the inventor, all of which are incorporated herein by reference. This application also claims priority to, and the benefit of, U.S. Non-provisional application Ser. No. 13/551,404, filed Jul. 17, 2012 also entitled System and Method for Providing Visual Job Information and Job Seeker's Information, naming Young Jea Shin as the inventor, all of which are incorporated herein by reference.

### FIELD OF THE INVENTION

The present disclosure relates to an automated process and associated computerized system for improving the recruitment process of qualified candidates for opened positions of different job postings, the process and system includes a platform for transforming information into a video posting displaying human and written video highlights based on the information, and more particularly to an online platform which includes multiple different functions, which includes uploading a text job opening and receiving a encoded video to imbed in internet sites where job seekers can access the posting, offering a more cost efficient alternative for a semi-manual job reports generation, and the automated process of generating a post-response candidate expectation video and support information.

### BACKGROUND OF THE INVENTION

The present application relates to multiple integrated tools to improve the job application process including a system and method for providing job information to job seekers in a visual or video format and/or job seekers' information to employers in a visual or video forma, offering a more cost efficient alternative for a semi-manual job reports generation, and the automated process of generating a post-response candidate expectation video and support information.

The same way trading, bartering, or employment has been around as long as our culture has existed, recruitment has also been used to match job seekers with employers. For a very long time, employment was mostly a word-to-mouth process where only known people were hired. Small businesses would organically grow by merging in family members or friends of family members. As our culture grew, so did the need for employment. Then came the invention of paper, and this medium defined the next centuries of job searching. In the conventional recruitment systems, employers post job information on the job board in a text-based format. The job seekers who apply for the job submit their resume and other information in a text-based format.

Many corporations have an ongoing flow of job openings to be filled by candidates and require an automated and simplified process for managing these job openings. Further, these corporations desire to reach a wider audience of potential job seekers and receive a larger proportion of well qualified and highly motivated applicants.

As each job opening differs and the unique and necessary qualifications for each posting differ, it may be difficult for potential applicants to distinguish certain requirements that are essential to the opening from other requirements that are used to give a profile of what may be a good applicant.

In the pre-internet era, employers used newspapers ads to post new openings. A human resource manager would make an executive decision as to the publication in different newspapers, covering different geographical areas, and this manager would also decide the size of the posting and the font size for each requirement. Job seekers by looking at the ad and the newspaper reputation would get some type of information as to which requirement will be strictly observed, and which will generally be useful to get a position. Other types of venues for job postings included small job related publications, and local television channels offering wanted ad services. In each case the distribution of the job offer was limited in its potential to reach qualified candidates and distinguish between the essential job requirements from secondary job requirements.

Today with the arrival of the internet and other types of online or wireless communications, job seekers are bombarded with text-based job descriptions. In this fluid format of information, it may be very difficult to distinguish between essential job requirements and secondary job requirements. It is also difficult to distinguish between important ads posted by employers and less important ads as these may be posted side by side on a board or list.

What is needed is a new and cost efficient system and process for facilitating the transfer of information between potential employers and job seekers and increasing the number of qualified applicants for any given job opening.

In the field of broadcast, publishing, and media edition, the authorship of a book, a pilot, or even a video clip created using any automated system is only the first part of the process. Even the best book, may fail unless it reaches the intended audience and is distributed to an audience in such a way and time as to achieve the desired result. What is desired are improvements associated with a system for providing visual or video format information to potential job seekers.

There are many other chronic problems and frustrations associated with the process of recruitment. From a legislative risk standpoint, employers must guard themselves from bias. Employees in charge of hiring could sometimes be left to make personal decisions instead of decisions for the good of the employer as a whole. Second, improving a process to include an applicant's appearance as part of the pre-selection process may result in prejudicial bias. Third, the most desire employees looking for work may have more alternatives and failure to move quickly to meet their demands will result in these individuals accepting other less desirable jobs. Fourth, a job applicant unaware of the internal processes of a corporation, may wrongfully perceives internal delays or deadlines as a lack of interest. Further, as part of the process, a potential job applicant may get the wrong messages sent by intermediaries who see the potential job applicant as a potential competitor. For these reasons, a new system is needed which resolves these problems at a minimum cost.

### BRIEF SUMMARY OF THE INVENTION

An exemplary embodiment of the present application is a multimedia recruitment system for delivering job and career opportunity information in a visual or video format to potential job seekers. The exemplary embodiment automatically converts text-based job descriptions provided by employers and/or recruiters relating job openings, into a high quality visual or video representations (“Job Reports”).

The Job Reports are then distributed to job seekers through a plurality of media including for example television (“TV”) channels or networks, on-line communication networks, wireless networks, etc. The exemplary embodiment provides a new recruitment system that brings the power of video and the convergence of media to the employers as well as to the job seekers.

An exemplary embodiment may provide job seekers or job candidates' information in a visual or video format. Unlike the conventional text-based resume, the exemplary embodiment may generate visual or video representations (“Video Introductions”) of the job seekers or job candidates' information. The exemplary embodiment may enable the job seekers or job candidates to submit their Video Introductions to employers through TV channels or networks, on-line communication networks, wireless networks, etc. The employers can reduce a screening process using the Video Introduction.

In another exemplary embodiment, the system designed to create Job Reports also allows for administrators to use the platform to broadcast widely the information to customized client web pages, a basic web portal managed by the system, external pages found on different external web pages such as social web sites, and to web pages of partners also engaged in distribution of related content. The system also allows for client customization of client web pages, distribution to external web pages of the choosing of the client, and to any other web page.

Furthermore, it has been found that while the generation of a Job Report linked with a job opening is always very highly useful, some employers to further accelerate the process and reduce costs will opt for an intermediary version of the Job Report called a Montage Video. This intermediary solution relies on the same technology with the exception of an on-air talent replaced by other video footage and a voice-over.

In another embodiment, either the Job report or the Montage Video can be produced in conjunction with an Expectation Video. This latest video utilizes a portion of the information used in the Job Report and/or the Montage Video and places post-submission context to the applicant.

### BRIEF DESCRIPTION OF THE DRAWINGS

FIG. 1 is a screen shot of a frame from a Job Report in an exemplary embodiment.

FIG. 2 is a screen shot of an exemplary contact information page displayed at the end of the exemplary Job Report as shown at FIG. 1.

FIG. 3 is a screen shot of a different frame from the Job Report shown at FIG. 1 in which an on-air talent interviews a company executive or a recruiter to deliver job information and/or company information.

FIG. 4 is a flow chart showing the interactions between an employer and a multimedia recruitment system used as part of the recruitment system to generate the Job Report shown at FIG. 1 in an exemplary embodiment.

FIG. 5 is a diagram showing how the a script and the graphic form are input to a teleprompter and a character generator as part of the multimedia recruitment system.

FIG. 6 is a diagram of portions of the multimedia recruitment system shown at FIG. 4 used to generate a Job Report as shown at FIG. 1 in an exemplary embodiment.

FIG. 7 is a diagram showing the distribution of the Job Report of FIG. 1 to TV channels in an exemplary embodiment.

FIG. 8 is a diagram showing the distribution of the Job Report of FIG. 1 in a Job Video .FLV format and ultimately posted on an exemplary website in an exemplary embodiment.

FIG. 9 is a diagram showing the distribution of the Job Report of FIG. 1 is posted on a mobile friendly website in an exemplary embodiment.

FIG. 10A is a flow chart showing production of a Video Introduction in an exemplary embodiment.

FIG. 10B is a block diagram showing the server side application and the client side application running on the multimedia recruitment system and the job seeker's device, respectively, in an exemplary embodiment.

FIG. 10C shows an interaction between the server side application and the client side application during the production of a Video Introduction in an exemplary embodiment.

FIGS. 10D-10F are screen shots of the user interfaces provided by the client side application running on the job seeker's device in an exemplary embodiment.

FIG. 11 is an exemplary network environment suitable for implementing a recruitment system for generating a Job Report as shown at FIG. 1.

FIG. 12 depicts a computing device suitable for practicing the recruitment system for generating a Job Report in a network environment.

FIG. 13 is a diagram associated with the input by an administrator on the system and platform for generating a Job Report to publish and distribute content to several external sources.

FIG. 14 is a diagram associated with the input by a client on the system and platform for generating a Job Report to customize web pages where content is distributed and published.

FIG. 15 is a sub-diagram of the process shown at FIG. 14 that describes particulars associated with the management of client pages with distributed content.

FIG. 16 is also a sub-diagram of the process shown at FIG. 14 that describes particulars associated with the management of other external distribution centers of the content generated by the system and platform.

FIG. 17 is also a sub-diagram of the process shown at FIG. 14 that describes the specific of XML data creation and publication

FIG. 18 is an illustration showing the different portions of a Job Report Information Form according to one embodiment of the present invention.

FIG. 19 is a diagram representing the different elements of the system to generate a Montage Video as a Job Report according to an embodiment of the present invention.

FIG. 20 is a diagram representing the different steps of generating a Montage Video as part of a production of a Job Report.

FIG. 21 is a diagram representing the process of providing multiple employer videos to enhance the probabilities of a Job Seeker being selected by the employer.

FIG. 22 is a diagram representing the of optimizing the process of hiring of a job seeker using a system for generating a plurality of videos related to the employment of the job seeker.

### DETAILED DESCRIPTION OF THE INVENTION

The Significance of The Invention

Recent case law has clarified the fact that new inventions, which are worthy of protection under the Patent Act must be more than simply a technical upgrade from one existing technology to a new technology. All inventions are worthy of protection as long as they are not simply applying improved efficiency to existing ideas. At the heart of this invention is a significant improvement which is much broader than simply applying audio-visual tools to another area. At the heart of inventions is an “Eureka” moment of inventiveness which must be proven to have happened independently of technical evolution of science.

The ultimate application of the use of audio-visual power to the area of job search is the show Celebrity Apprentice® on NBC®. This show, invented by Mark Burnett in 2004. In this reality show, one CEO uses hours of footage and multiple tasks to help select an employee. As part of the weekly process, a set of 18 candidates are matched and each week one is eliminated until one remains. This process is long and costly. As part of the earlier versions of the show, the job function were given very broadly (e.g. “you will be my apprentice working on this building”) along with a very simple description of the salary (e.g. “you will be paid at least $250,000 per year”). Because of the popularity of this show, other programs also offer live competitions for employment. In each case, one individual is hired under rather strange conditions. One trap of hindsight is to think that because audio-visual tools allow for these live shows to take place, that extrapolation suggests that simpler systems would also be simple to implement. That is not the case.

We all know that after decades of producing popular comic books, the popularity of Marvel® movies has recently exploded. We all understand that taking a written story and producing a movie is completely different than producing a comic book. We also all understand that an invention which would automate part of the process and take an author's story and instead of producing a comic book or a movie would produce some hybrid intermediary would be novel and non-obvious. The same can be said in the process of hiring of individuals. The suggestion that any new system which helps manage and expedite generation would be a natural consequence of technology is wrong

To understand the fact that the invention is not a simple normal growth from known technology, one must look at the time of this invention. The earliest priority date is 2010, more than two decades after the arrival of network news and of the internet as a whole. From the period of 1990 to 2010, the different audio-visual content providers owned computers and cameras and were able to interface with remote users, yet, during this period and still mostly today, the paper/text method of recruitment is generally in use. Many large employers with hundreds of job postings have been unable to reach this technology because it relies on more than simply the extrapolation of tools to a new field.

General Description

As shown, this invention relates at least in part to a multimedia recruitment system for providing and transforming job related information in a visual or video format and for generating a visual or video representation of this information in what is referred to as a Job Report. A text-based job description is received from an employer and/or a recruiter and in turn this description is used to generate a visual or video representation of associated with the job description.

The invention provides a multimedia recruitment system for providing to a job seeker or a job candidate information in a visual or video format relating to a job opening. In addition, the multimedia recruitment system also provides to the job seeker or the job candidate a tool for generating a visual or video representation of the job seeker or job candidate's information back as a response to the Job Report. The visual or video representation of the job seeker or the job candidate with personal information sufficient to answer the job opening is referred to as a Video Introduction.

The visual or video format or representation may include at least a series of image or picture frames for a predetermined time period or duration. The visual or video representation may be provided in a wide range of video formats, which use different COmpressors-DECcompressorS (CODECS) to encode and compress video data. The possible contemplated video formats include, but are not limited to, .3GP (3GPP Multimedia File), .FLV (Flash Video File), .MPG (MPEG Video File), .WMV (Windows Media Video File). The visual or video representation may also include an audio stream of data.

In addition to a Job Report linked with a job opening, what is also contemplated is a platform and system which can also generate an intermediary version of the Job Report called a Montage Video. This intermediary solution relies on the same technology with the exception of an on-air talent replaced by other video footage such as B-Roll, animations from an employer website, screen shots, mounted over a voice-over version of the same script.

The Job Report or the Montage Video can be produced alone or in conjunction with an Expectation Video. This latest video utilizes a portion of the information used in the Job Report and/or the Montage Video and enhances the information with post-submission context to the job seeker to allow the process to attract and retain the best applicant by making the employer more attractive. In some embodiments, the Expectation Video is used as part of the input information for a Job Report and/or a Montage Video, in other embodiments, the Expectation Video is generated from input information from the Job Report or the Montage Video.

Description of the Job Report

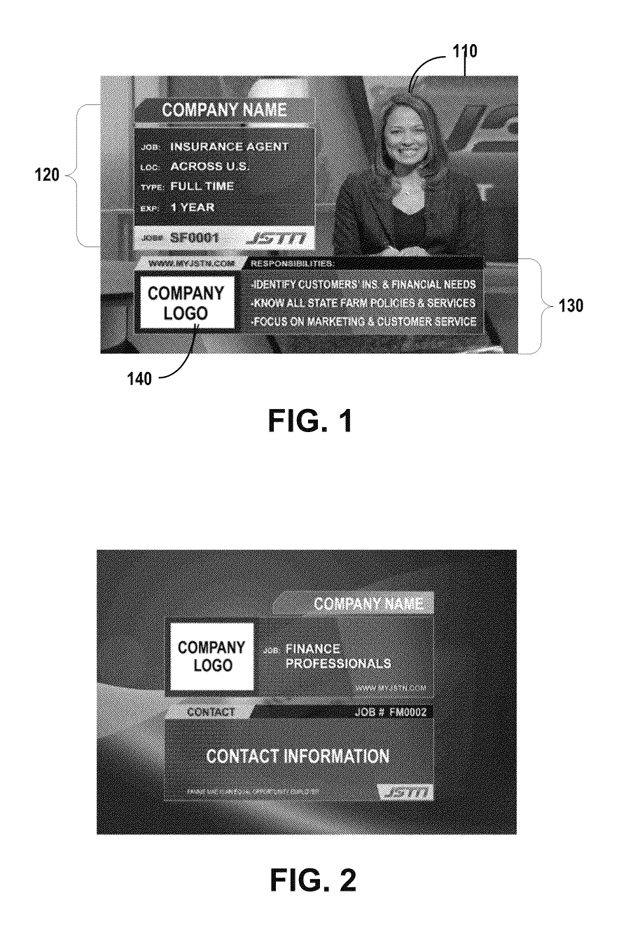

FIG. 1 is a screen shot of one of the frames of an exemplary Job Report. The invention generates for example a Job Report that is specific and customized to an individual job opening. The Job Report may have a predetermined fixed length of time or a variable length of time depending on the job description provided by an employer. For example, the Job Report may be 30 seconds in length. In the Job Report, the job description may be as shown partly delivered by an on-air talent 110 in a network news style. While one type of delivery is shown, one of ordinary skill in the art will appreciate that other types of delivery styles aside from the network news style may be used. For example, a delivery may include the Montage Video style described below.

The on-air talent 110 may first introduce a job listing while relevant position information is displayed as shown at 120, 130 on the side and/or bottom of the screen as shown. The Job Report may contain the employer or company's logo 140 and key statistics about the company and the job positions available. In the background, as shown, the logo of a third party offering services associated with the production of Job Reports (i.e. JSTN) may be displayed in the back, on the relevant positions 120, 130.

The Job Report as shown at FIG. 1 may include several graphic areas 120 and 130 displayed at different portions of the screen. In the example shown at FIG. 1, one of the two graphic areas is located on left side of the screen, and the second graphic area is located on the bottom of the screen. The first graphic area 120 may be provided at the left upper corner of the screen. The graphic area may display information such as an employer's name, a job title for the position, a job location for the position, a job type, a required experience/education level and a unique job number.

The second graphic area 130 as shown may be provided at the bottom area of the screen. In the second graphic area 130, different information may be displayed in sequence or even scrolled as for stock or live news tickers. For example, an employer information may be displayed next to other important information 130. This information may include benefit information, the responsibilities of the position, and then the qualifications of the position. This area 130 may include a single or a plurality of lines for the display the this information. As shown, the second graphic includes three lines each with up to 45 characters. The employer's logo 140 may be displayed in the second graphic area. While one possible configuration of information display is shown, what is contemplated is the use of any known techniques to display as an overlay over an anchor the information.

FIG. 2 illustrates a screen shot of a job and contact information page generally reserved for the end portion of the Job Report. On FIG. 2, at the top of the screen, an employer name, an employer's logo and a job title is be displayed. At the bottom of the screen, the employer's contact information, a job identification number and a disclaimer is displayed. Once again, as shown the logo of a third party service provider may be imbedded within these images to help give every Job Report describing jobs from a large number of different potential employers an overall look and feel. While one possible display of information is shown, what is contemplated is the display of information in any number of configurations.

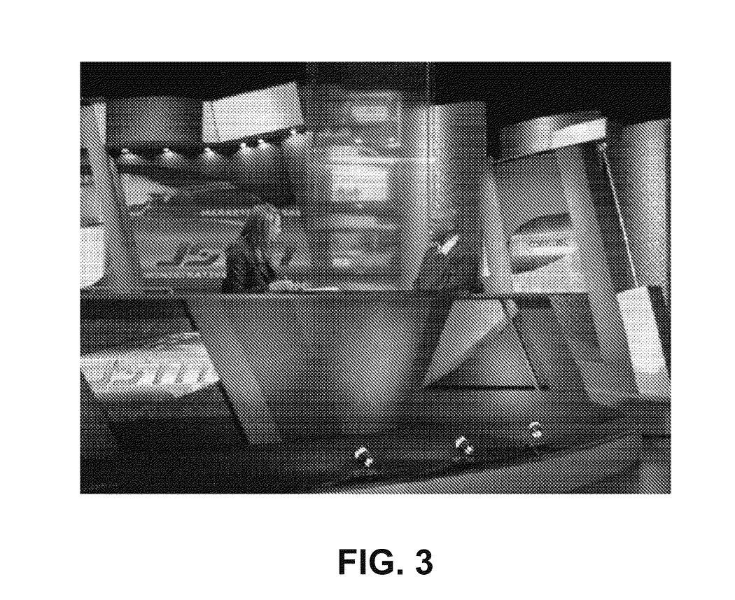

FIG. 3 shows a screen shot of an exemplary Job Report from a different camera angle in which an on-air talent 110 interviews a company executive or a recruiter to help deliver some of the company information. During the interview, the company logo may be displayed on the background of the Job Report or it may be placed in different areas around the display area. While FIG. 3 shows one possible different camera angle or method of display of the information using external actors or other sources of information, what is contemplated is the use of any incrustation of video, or information in any format known in the news industry. In addition to inputting the graphic form into the character generator, the second video includes information selected from a group consisting of a film of an external actor, incrustation of a video, information from the news industry.

The Production of a Job Report

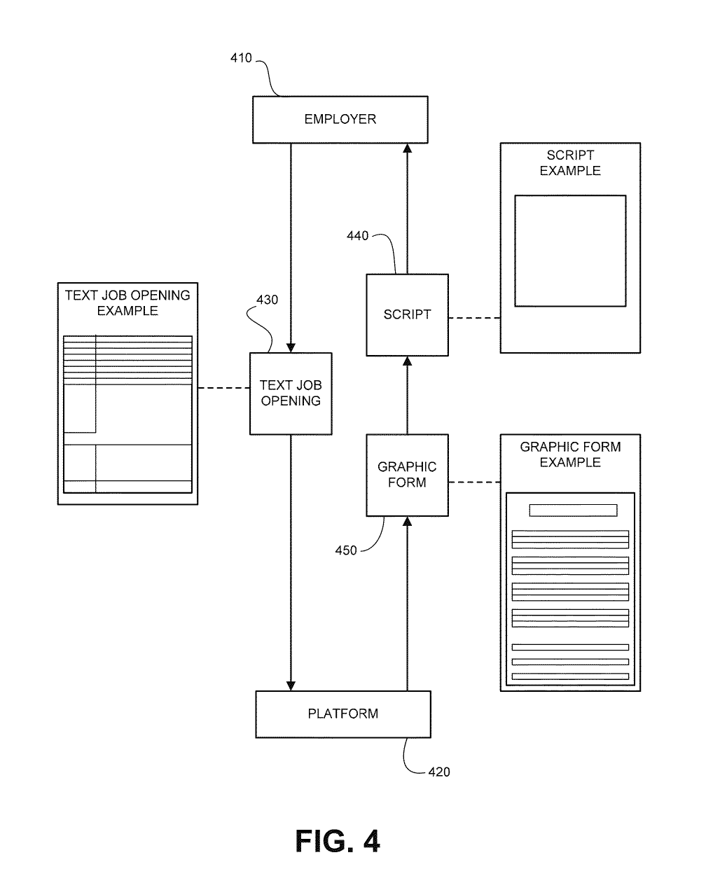

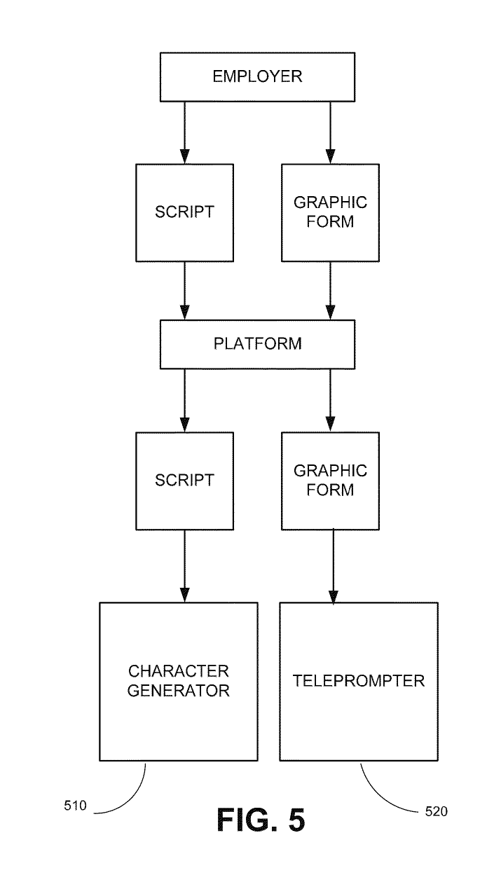

FIG. 4 is a flow chart showing the interactions between an employer 410 who must fill a job vacancy and the multimedia recruitment system shown here as a platform 420 to produce a Job Report as shown at FIG. 1. An employer provides a text-based job description 430, an in an alternate embodiment, the employer uploads the text-based job description 430 using a pre-populated form in a text editor format and more precisely using an online web form. The multimedia recruitment system 420 can also generate a script 440 for the on-air talent 110 to read out loud using a teleprompter 520 as shown at FIG. 5 and to be incorporated as part of the Job Report shown at FIG. 1. The script 440 is then sent in some embodiments back to the employer 410 for approval (as illustrated by the arrow). As illustrated at FIG. 4 in a page drawn with the label ‘script example,’ the script 440 is text to be read out loud by one or several actors as part of the Job Report.

At the same time, the multimedia recruitment system 420 may generate and send graphic forms 450 directly for processing as shown at FIG. 5 or for the employer 410 to fill out. The graphic forms 450 are text to be displayed on the screen of the Job Report as discussed above with reference to FIG. 1. After the employer 410 approves the script 440 and alternatively also fills out the graphic form 450 if one is generated, the employer 410 returns the script 440 and the graphic form 450 to the multimedia recruitment system. These exchanges of information between the employer 410 and the platform 420 also the recruitment system for generating a Job Report are designed to be optimized and minimized in size and volume. Employers 410 often look for many closely related candidates and the different scripts 440 and graphic forms 450 will be closely related as the text job opening 430 will also be extremely similar (e.g. two engineers may have only the level of experience different). By using forms and validation steps as part of this process, the employer 410 and the platform 420 can be programmed to generate the different intermediate documents 430, 440 and 450 in less time and effort.

FIG. 5 is a diagram showing how the script 440 from FIG. 4 is input to the teleprompter 520 to be read out-loud by the talent 110 as shown at FIG. 1. The graphic forms 450 are in turn input to a character generator 510 in the multimedia recruitment system as shown at FIG. 4. The multimedia recruitment system 420 may include the character generator 510 and the teleprompter 520. FIG. 5 shows how once the employer 420 has approved both the script 440 and the graphic form 450, the employer 410 can provide the script 440 and the graphic form 450 to the platform 420 also described as the multimedia recruitment system and both of these documents are in turn sent to two elements 510 and 520 that can also be considered part of the platform 420 that are useful external tools to generate the Job Report. In an alternate embodiment, the character generator and the teleprompter 510, 520 are internal to the multimedia recruitment system but external to the platform 420.

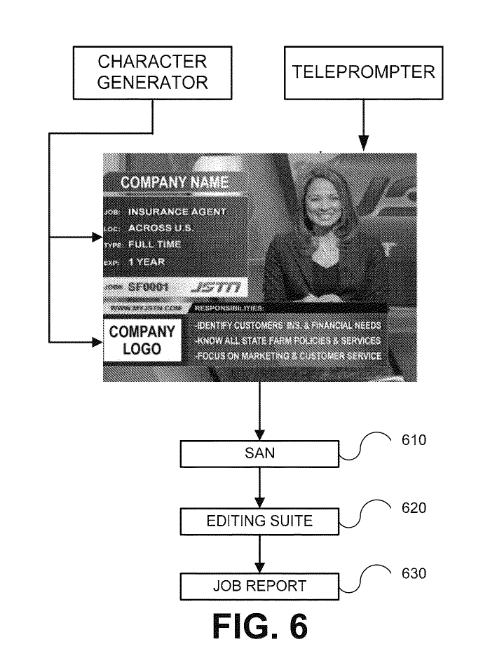

FIG. 6 is a diagram of an exemplary multimedia recruitment system that generates a Job Report with a third portion of the entire process illustrated in full by FIGS. 4-6. When the multimedia recruitment system 420 produces a Job Report, the multimedia recruitment system feeds the graphic information from the character generator and the script to a teleprompter while taping. The Job Report with graphic areas and the Job Report without graphic areas are recorded in the video tape recorders as well as captured in the Quicktime video format, which is known as .MOV file. The .MOV files are stored in the Storage Area Network (SAN) 610. The video clips with graphic areas are edited in the editing system 620 to produce a predetermined length of a Job Report 630.

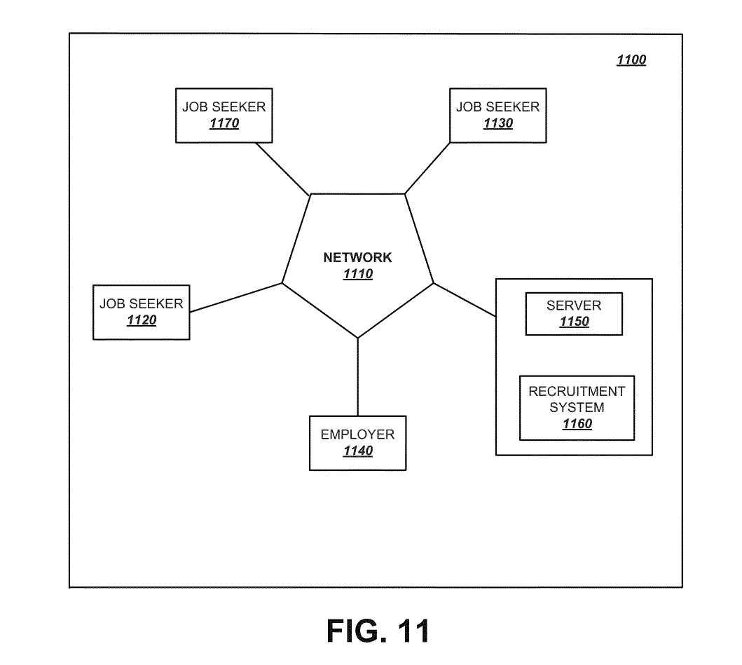

What is described is a recruitment system 420 for generating a Job Report as shown in FIG. 1 in a network environment as described in FIG. 11. The recruitment system 420 includes a server 1150 as shown at FIG. 11 to house the recruitment system 420 coupled as shown to a plurality of job seeker devices 1120, 1130, and 1170 and at least an employer device 1140 via a communication network 1110.

In the system 420, an employer 410 uploads using the employer device 1140 a text-based job description 430 relating to a job opening to the server 1150 via the communication network link 1110 between the employer device and the server (shown by lines between the units). The server 1150 includes a multimedia requirement system 1160 also shown as 1200 for the production of a Job Report produced by transforming the text-based job description 430 using a platform 420 into a script 440 and a graphic form 450 by inputting the script 440 into a teleprompter 520 to be read by an on air talent 110 and recorded using a camera (not shown) as a first video. Further, the system 420 produces the Job Report as shown at FIG. 1 by inputting the graphic form 450 into a character generator 510 for producing a second video and by storing the first and second videos in a storage area network 610 as shown at FIG. 6.

Finally, the system 420 also allows for editing the first and second videos using an editing suite 620 to produce with both the first and second videos the Job Report as shown at FIG. 1. The Job Report as shown at FIG. 11 can be viewed by at least a job seeker using one of the plurality of job seeker devices 1120, 1130, and 1170 over the communication network 1110 from the server 1150.

In another embodiment, Job Report is uploaded by the employer 410 using the employer device 1140 from the server 1150 and the Job Report is viewed on a employer website instead of the server 1150 after being uploaded in a video format and merged into an HTML web page.

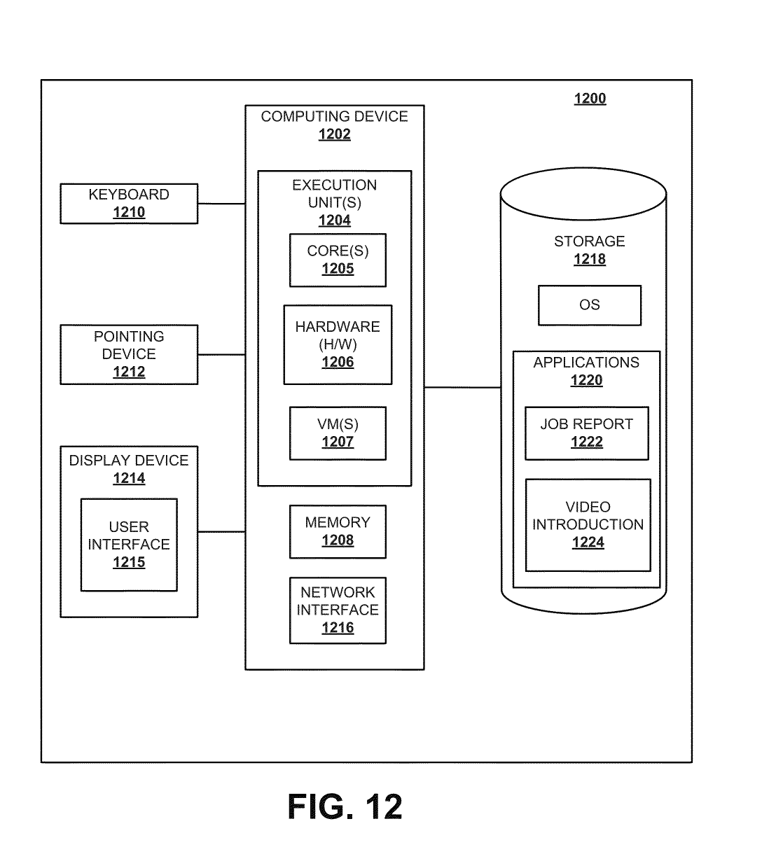

What is also contemplated and described is a method for producing a Job Report as shown at FIG. 1. The method is performed by conducting using the hardware as described above the steps of (a) uploading a text-based job description 430 relating to a job opening in a multimedia requirement system 420 using an employer device 1140 connected to a server 1150 hosting the multimedia requirement system 1160. The multimedia requirement system 1160 as shown at FIG. 12 can be located in a computing device 1202 with an execution unit 1204, a memory 1208, and a network interface 1216 in communication with a storage 1218.

The next step is to transform the text-based job description 430 using the platform 420 into a script 440 and a graphic form 450, and then inputting the script 440 into a teleprompter 520 to be read by an on air talent 110 and recorded using a camera (not shown) as a first video. The next step is the input of the graphic form 450 into a character generator 510 for producing a second video, and finally storing the first and second videos in the storage 610 and editing the first and second videos 620 to produce a Job Report.

Other possible steps include having at least one of a plurality of job seekers through their own devices uploading the Job Report on a job seeker device 1120, 1130, and 1170 connected to the multimedia requirement system 420. The Job Report can also be viewed using a video streamer from a web-based interface, and using a review step as part of this method.

Distribution of Job Report

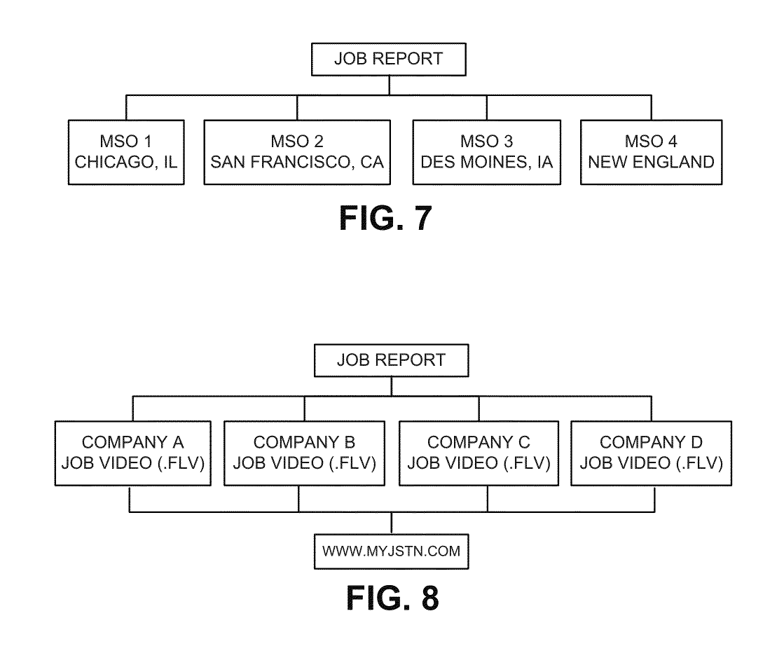

FIG. 7 is a diagram showing how the Job Report is distributed to those who broadcast the Job Reports via TV channels or networks. Once the Job Report is produced, the multimedia recruitment system prints out the Job Report on the video tapes and distributes the video tapes to dedicated market MSOs (Multiple System Operators), such as Comcast, Time Warner, Cox and Mediacom, etc. The Job Reports are broadcasted via the TV channels or networks. In an embodiment, the Job Report may be distributed using a satellite or an optical fiber.

FIG. 8 is a diagram showing that the Job Report is posted on a website in an exemplary embodiment. The multimedia recruitment system may transfer each Job Report into a Flash Video File, which is known as .flv files, and send the .flv files to the website to post the Job Report on the website.

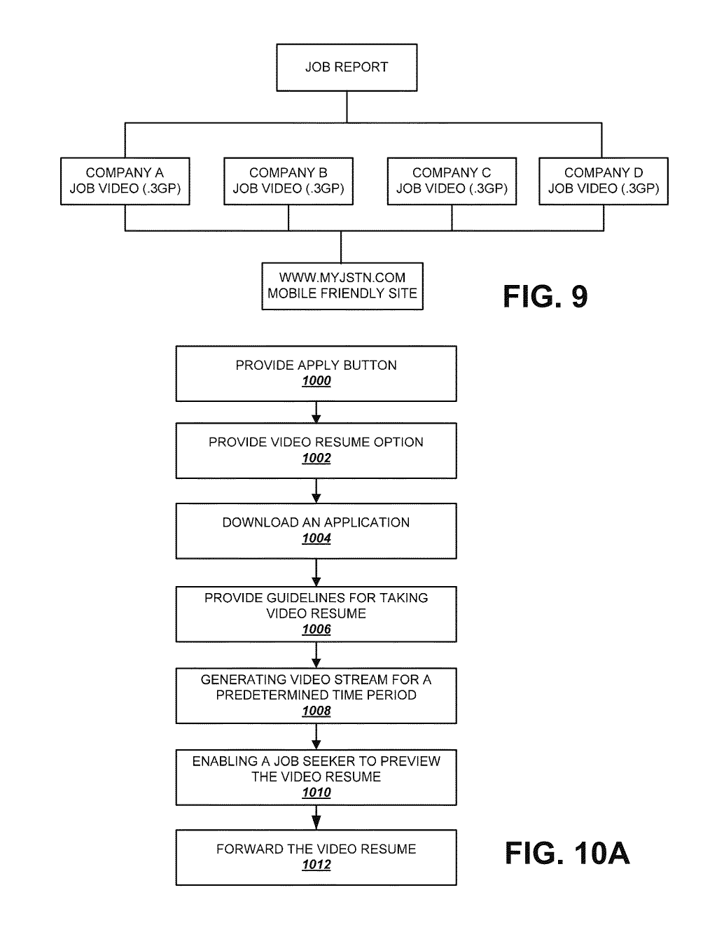

FIG. 9 is a diagram showing that the Job Report is posted on a mobile friendly website in an exemplary embodiment. The multimedia recruitment system may transfer each Job Report into mobile phone video file, which is known as .3gp, to post the Job Report on a mobile friendly site. The Job Report can be viewed on the mobile phone, which can access the mobile friendly site

Video Introduction Production

To create a Video Introduction, the job seeker's device, such as a TV set, a computer and a mobile device, may include a camera to generate a video data stream in the job seeker's device.

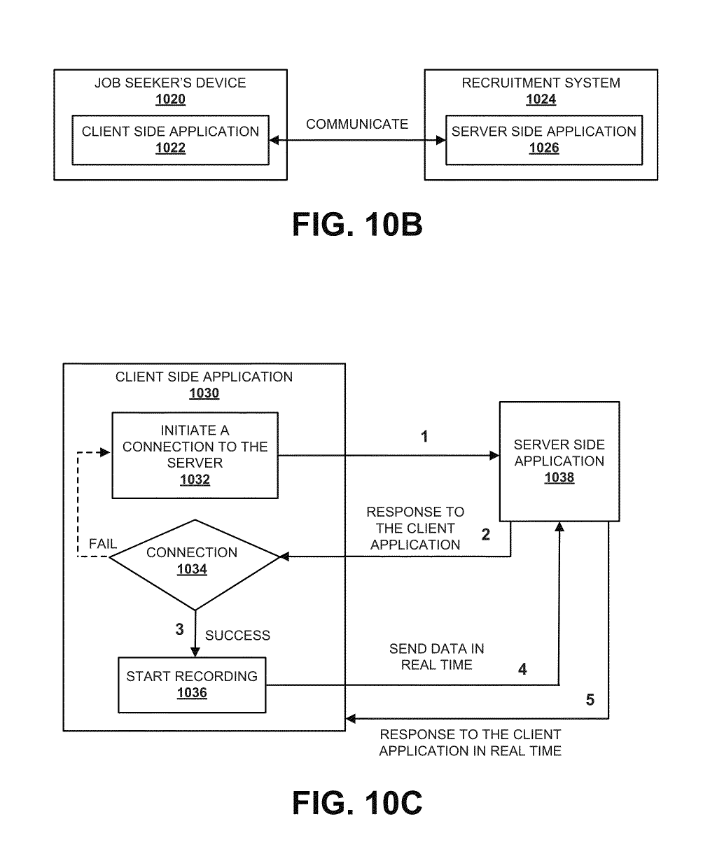

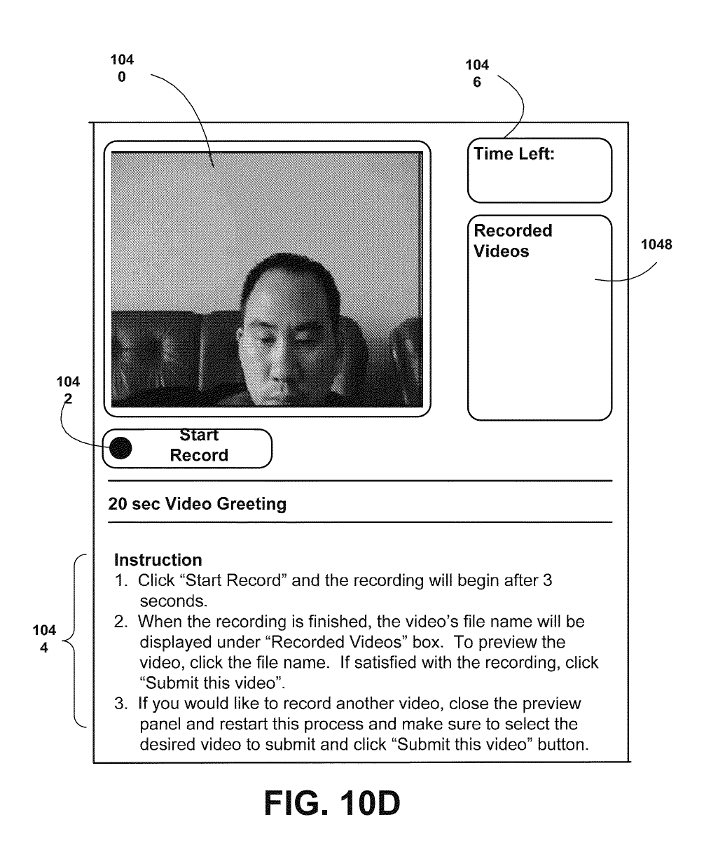

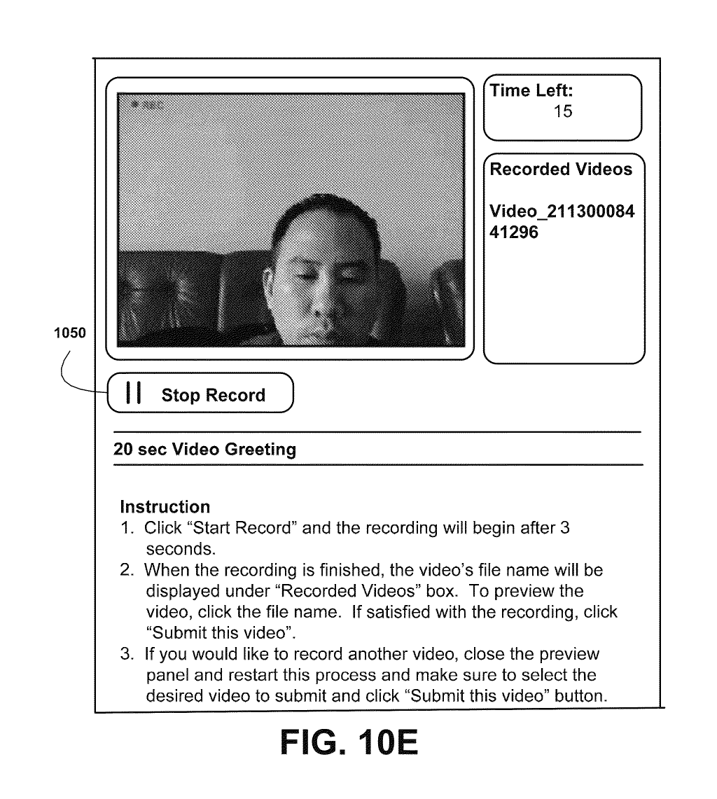

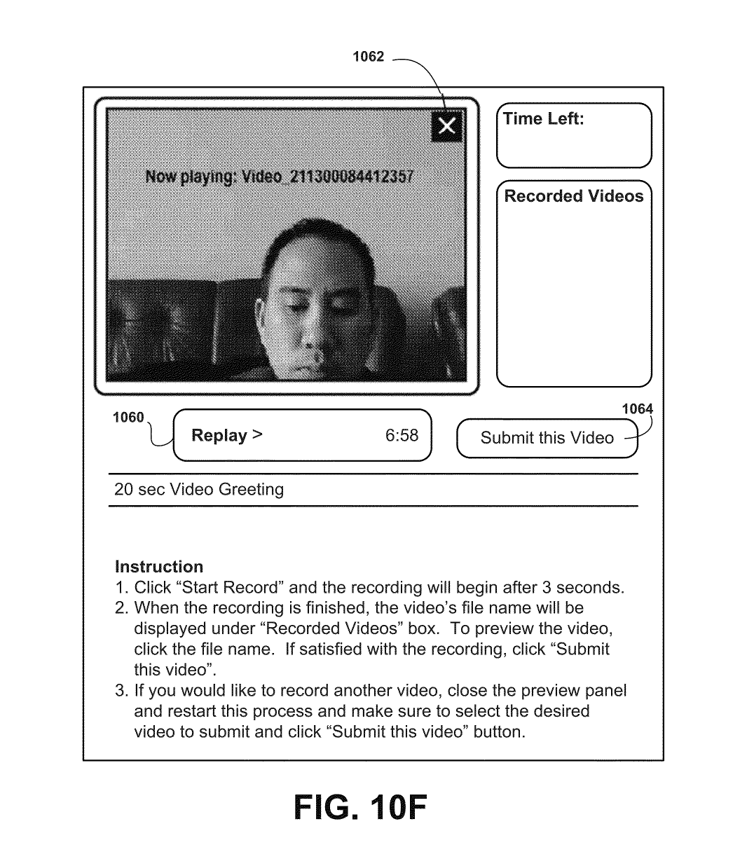

FIG. 10A is a flow chart showing the production of a Video Introduction in an exemplary embodiment. As described above, a job seeker may view a Job Report on a job seeker's device connected to the multimedia recruitment system via a network. The multimedia recruitment system may provide the Job Report along with an Apply button for the job seeker to apply for the job described in the Job Report 1000. When the job seeker presses the Apply button, the multimedia recruitment system may provide an additional button for the Video Introduction option 1002. When the job seeker selects the Video Introduction option, then the multimedia recruitment system may enable the job seeker to create a Video Introduction through the multimedia recruitment system. To create the Video Introduction, the job seeker may download an application from the multimedia recruitment system 1004.

FIG. 10B is a block diagram showing that a client side application 1022 is downloaded from the multimedia recruitment system 1024 and runs on the job seeker's device 1020. The multimedia recruitment system may be implemented in a server, such as a media server, and include a server side application 1026. The client side application may communicate with the server side application to establish a channel between the job seeker's device and the multimedia recruitment system for the transmission of video data in real time.

FIG. 10C shows the communication between the client side application 1030 and the server side application 1038 in an exemplary embodiment. The client side application initiates a connection to the multimedia recruitment system (1032). If the server side application is ready to receive images or streaming from the client side application, the server side application sends a message that the server is ready. The client side application receives a response from the sever side application and determines whether the connection is established for the transmission of video data 1034. If the connection fails, the application repeat the above process. If the connection is established, the application transmits the video data in real time as recording of the Video Introduction starts 1036.

In order to enable the job seeker to record a Video Introduction, the client side application may provide guidelines for recording the Video Introduction 1006 in FIG. 10A. FIGS. 10D-10F are exemplary user interfaces provided by the client side application in the job seeker's device. The initial user interface shown in FIG. 10D may include image window 1040, “Start Record” button 1042, text-based Instruction 1044, “Time Left” box 1046 and “Recorded Videos” box 1048. The image window displays the image captured by a camera in the job seeker's device. The text based Instruction may include information on the procedures for the job seeker to create a Video Introduction. For example, the guidelines may include information on the position of the job seeker's face on the image window. The “Time Left” box displays the time left to finish recording the Video Introduction. The “Recorded Videos” box may displays the file name of the Video Introduction recorded. The “Recorded Videos” box may display a plurality of file names when the job seeker records a plurality of Video Introductions.

*** If the job seeker pushes the “Start Record” button, recording of a Video Introduction may start. The client side application may receive a video stream from the camera and send the video stream or images to the multimedia recruitment system in real time. The multimedia recruitment system manages the video stream and images to create a Video Introduction file and save the Video Introduction file in the multimedia recruitment system or other file storage devices.

The client side application may receive video data for a predetermined time to create a Video Introduction 1008 in FIG. 10A. FIG. 10E shows an exemplary user interface provided when a Video Introduction is being recorded. The remaining time may be displayed in the “Time Left” box. When the Video Introduction is being created, a file name may be automatically assigned and displayed in the “Recorded Videos” box. A job seeker may stop recording the Video Introduction by pushing “Stop Record” button 1050. A job seeker may create a plurality of Video Introductions and select one of the plurality of Video Introductions for submission to an employer.

When a Video Introduction has been created, the job seeker may preview the Video Introduction before submission 1010 in FIG. 10A. FIG. 10F shows an exemplary user interface provided when a Video Introduction has been recorded. The user interface may provide “Replay” button 1060 to preview the Video Introduction. The job seeker can delete the recorded Video Introduction using “x” mark 1062 on the image window. The job seeker may repeat the above operations to create a plurality of Video Introductions until the job seeker is satisfied with one of the Video Introductions. The job seeker may submit a Video Introduction using “Submit” button 1064. The multimedia recruitment system may submit the Video Introduction to an employer 1012 in FIG. 10A.

When the job seeker approves the Video Introduction, the application may disconnect from the multimedia recruitment system.

FIG. 11 is an exemplary network environment 1100 suitable for implementing an exemplary embodiment. Environment 1100 may include a server 1150 coupled to job seeker's devices 1120, 1130 and 1170 and an employer's device 1140 via a communication network 1110. A multimedia recruitment system 1160 may be provided in server 1150. The employer may post information on job openings on a website in multimedia recruitment system 1160. Using the multimedia recruitment system, the employer is able to post the job opening information in a visual or video format. Job seeker's devices 1120, 1130 and 1170 may access server 1150 to search job openings posted in multimedia recruitment system 1160. Server 1150 and multimedia recruitment system 1160 may be managed by the employer or a third party recruiter. Communication network 1110 may include a television network, Internet, intranet, Local Area Network (LAN), Wide Area Network (WAN), Metropolitan Area Network (MAN), wireless communication network, etc.

FIG. 12 depicts exemplary computing device 1200 suitable for practicing an embodiment. Computing device 1202 may include execution unit 1204, memory 1208, keyboard 1210, pointing device 1212, network interface 1216 and storage 1218. Execution unit 1204 may include hardware or software based logic to execute instructions on behalf of computing device 1202. For example, in one implementation execution units 1204 may include one or more processors, such as a microprocessor. In one implementation, execution unit 1204 may include single or multiple cores 1205 for executing software stored in memory 1208, or other programs for controlling computing device 1202. In another implementation, execution unit 1204 may include hardware 1206, such as a digital signal processor (DSP), a graphics processing unit (GPU), a field programmable gate array (FPGA), an application specific integrated circuit (ASIC), etc., on which at least a part of applications can be executed. In another implementation, execution units 1204 may include virtual machine (VM) 1207 for executing the instructions loaded in the memory 1208. Multiple VMs 1207 may be resident on a single execution unit 1204.

Memory 1208 may include a computer system memory or random access memory (RAM), such as dynamic RAM (DRAM), static RAM (SRAM), extended data out RAM (EDO RAM), etc. Memory 1208 may include other types of memory as well, or combinations thereof. Computing device 1202 may include input devices, such as keyboard 1210 and pointing device 1212 (for example, a mouse) for receiving input from a user. A display device 1214, such as a computer monitor, may be provided. Optionally, keyboard 1210 and pointing device 1212 may be connected to display device 1214, or a soft keyboard may be implemented by a touchscreen input device. A graphical user interface (GUI) 1215 may be shown on the display device 1214. Computing device 1202 may include other suitable conventional I/O peripherals. Moreover, computing device 1202 may be any computer system such as a workstation, desktop computer, server, laptop, handheld computer, smartphone, or other form of computing or telecommunications device that is capable of communication and that has access to sufficient processor power and memory capacity to perform the operations described herein.

Additionally, computing device 1202 may include network interface 1216 to interface to a Local Area Network (LAN), Wide Area Network (WAN) or the Internet through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. Network interface 1216 may include a built-in network adapter, network interface card, personal computer memory card international association (PCMCIA) network card, card bus network adapter, wireless network adapter, universal serial bus (USB) network adapter, modem or any other device suitable for interfacing computing device 1202 to any type of network capable of communication and performing the operations described herein.

The storage device 1218 may be, for example, a hard-drive, CD-ROM or DVD, for storing an operating system (OS) and for storing application software programs, such as multimedia recruitment system 1220. Multimedia recruitment system 1220 may run on any operating system such as any of the versions of the Microsoft® Windows operating systems, the different releases of the Unix and Linux operating systems, any version of the MacOS® operating system for Macintosh computers, any embedded operating system, any real-time operating system, any open source operating system, any proprietary operating system, any operating systems for mobile computing devices, or any other operating system capable of running on the computing device and performing the operations described herein.

Furthermore, the operating system and multimedia recruitment system 1220 can be run from a bootable CD, such as, for example, KNOPPIX®, a bootable CD for GNU/Linux.

Multimedia recruitment system 1220 may enable an employer to produce a Job Report 1222 for a job opening. The job seekers may generate a Video Introduction 1224 using the multimedia recruitment system 1220. The generated Video Introduction 1224 may be submitted to the employer through the multimedia recruitment system 1220. With the above features, the multimedia recruitment system 1220 may enable the employer and the jobseekers to communicate with each other.

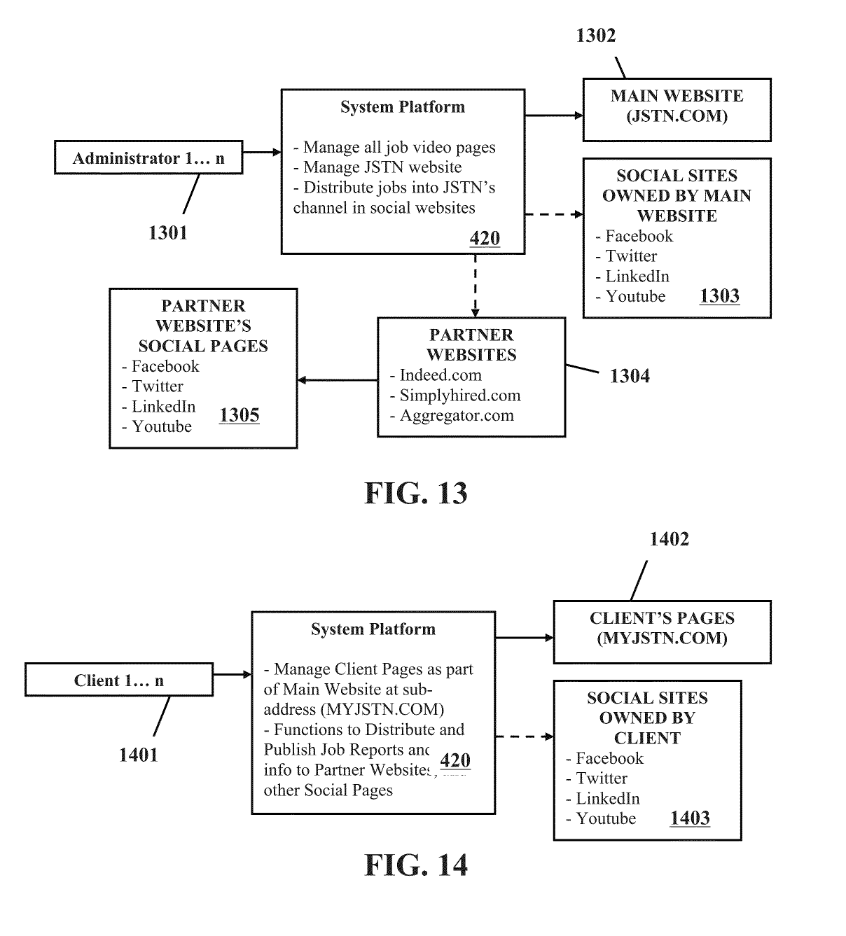

As shown at FIGS. 13-17, once the system has produced as described above a Job Report using the multimedia recruitment system for providing and transforming job related information in a visual or video format, the Job Report information is then broadcast and distributed using several means to reach a wider audience and further increase the efficiency of the process.

The job search process is a time intensive process that ultimately tries to match relevant candidates to the best job offers. Employers desire qualified or over-qualified employees at the lowest salary while job seekers try to optimize their salaries by applying on job postings for which they may be under-qualified. The process of broadcasting different related job openings in any given sector allows for applicants to understand their level of qualification and apply to the right posting. For example, if an employer can find a way to convey to potential applicants the fact that it has the same job opening for operators with 2, 4, and 6 years of experience, and that these jobs are paid $25,000, $27,500 and $30,000 yearly respectively, an applicant with 3 years of experience will be dissuaded from applying on the two of the three job openings.

To help convey this information, several types of web pages are contemplated that help job seekers get a broader view of the employment offers and situation as offered by a single employer. For example, a home web page can include (a) a search bar with tools for indexing based on job title, skills, keywords, or even geographical location, (b) a rotation of features employers along with their Job Reports, (c) the logo of featured partners for external access, and (d) general menu information like tips, job categories for rapid search, etc. In one embodiment, the element (b) is placed predominantly in the middle of the page in a larger size.

In a second possible type of web page, an industry specific page or a topic specific page is created where the web page is structured as (a) a search bar with tools for indexing based on job title, skills, and geographical location, (b) a rotation of industry specific or topic specific information, video or Job Reports, (c) the logo of industry specific or topic specific employers, (d) a list of the different main categories of jobs in the industry listed in order of importance and relevance, and (e) Job Reports of currently available jobs within the specific industry. In one embodiment, element (c) is placed alongside (b).

Several types of employer pages are also contemplated. In a first type, the logo is the logo of a specific employer and instead of a list of different main categories of jobs, what is found is a description and cultural insight of the employer. Then specific Job Reports for all currently available jobs at this specific employer are then listed and any other external information such as cultural insight videos are listed and available for broadcast. In a second type of employer specific page, the page can include small shortcut external icons that direct to Facebook®, Twitter®, LinkedIn®, or other social media websites. These links to external sites direct a user, via a single click to the social portal of the employer where the employer can have already broadcasted the Job Reports. In another embodiment, a large button allows to access all of the job openings of the employer in other formats or other sites outside of the platform. In yet another embodiment, the page the Job Report displayed includes textual information related to the job opening, an “apply now” button, a link to the written job description, and a link to related job openings. What is also contemplated is the creation of pages with the same type of information but where no Job Report is found in the page.

FIG. 13 illustrates a diagram associated where one of a plurality of N administrators 1301 (to indicate a plurality, the mathematical expression 1 . . . n is used) can access the platform 420 using log-in protocols for the generation of Job Reports. The administrator 1301 is given access to generate information that is relayed out or broadcasted from the platform 420 on many different places on the internet. For example, the platform 420 can be programmed and configured to send information to a main website like the JSTN.COM website 1302, to social sites associated by the operator of the main website, for example social sites like Facebook®, Twitter®, Linkedln®, or Youtube® to name a few 1303.

The update of the different social sites 1303 and possibly partner sites 1304, for example indeed.com, simplyhired.com, and aggregator.com can be done by having an access to upload information into these sites as an administrator or a user. The publication to these sites are done generally using a coded XML interface or any other software that sends access information, along with the code

In turn, each of these partner sites 1304, who already have access and code validation to different social pages 1305 owned by these partner sites 1304 can use the information sent from the platform 420 and relay the information to the social sites 1305. For example, An administrator of JSTN™ 1301 uses the platform 420 to generate a Job Report relating to a new IT opening. The Job Report can be sent either to the main JSTN.COM website 1302, also to different social websites owned by JSTN 1303, or sent to different other websites 1304 ready to publish the job opening in the video format. These partners 1304 can in turn distribute to their own social pages 1305 further increasing the distribution of the pages.

FIG. 14 describes a relatively similar system of push of content but where a client 1401 is able to access a specific client page via the system platform 420 as a sub address of the main website 1302 such as MYJSTN.COM 1402. The content of these client pages is described above. The client 1401 is also able to push the content to the Client's page or any other social media site 1403 owned by the client 1401. While two examples are given, what is contemplated is the distribution to a large number of external locations and sites to better the distribution of the Job Report or any associated data.

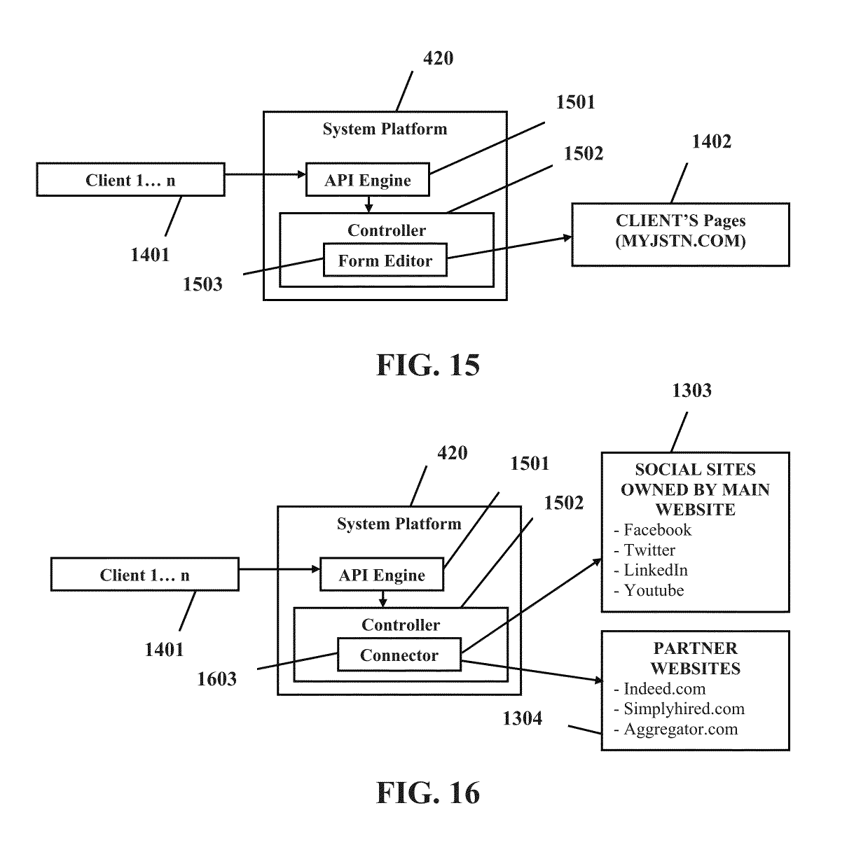

FIG. 15 is a sub-diagram of the process shown at FIG. 14 that describes particulars associated with the management of client pages with distributed content. In this diagram, the system platform 420 includes an Application Programming Interface (API) 1501 that then directs the information to a Controller 1502 that regulates a form editor 1503 to send and customize the Client's pages on MYJSTN.COM 1402. In a different embodiment shown at FIG. 16, the form editor 1503 is replaced in the Controller 1502 with a connector 1602 that allows to edit the content to a different format capable of being used by Social sites 1303 or partner websites 1304.

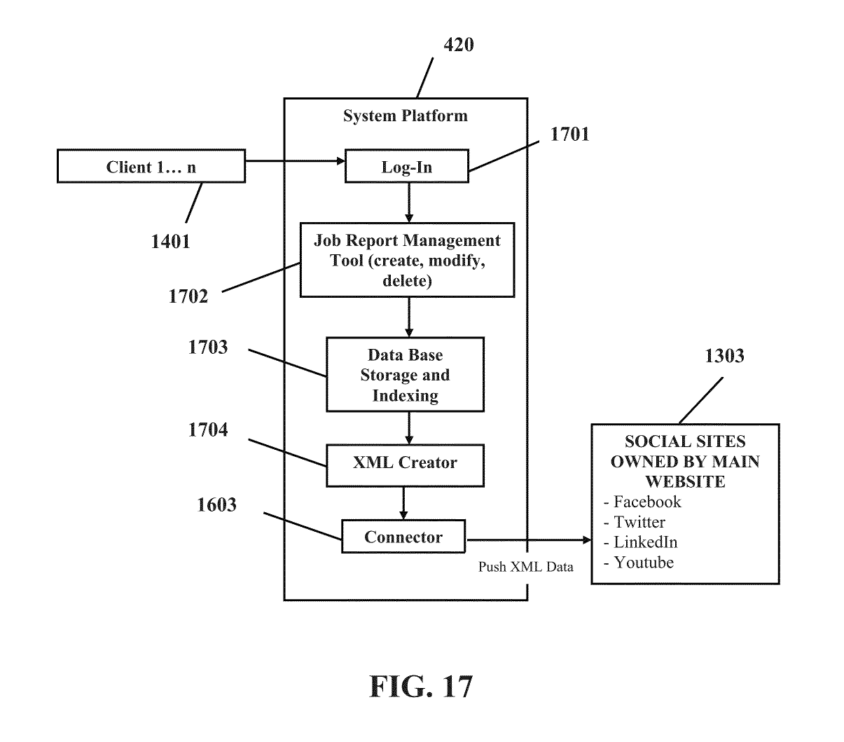

FIG. 17 is also a sub-diagram of the process shown at FIG. 14 that describes the specific of XML data creation and publication. A client 1401 will log in 1701 to the platform 420 and then enter into a Job Report Management tool 1702 designed to help create, modify or delete the different Job Reports as described earlier in this document. The Job Report is then stored and/or indexed 1703 in a database. A creator engine capable of generating code for example in the XML format 1704 sends the data to the Connector 1603 as described in FIG. 16 before the XML data is pushed outward for the different social sites 1303. For example, if Facebook® requires a log in, and will only accept a very unique type of script, then the XML Creator is set up to generate the XML text that can be accepted by the social interface 1303.

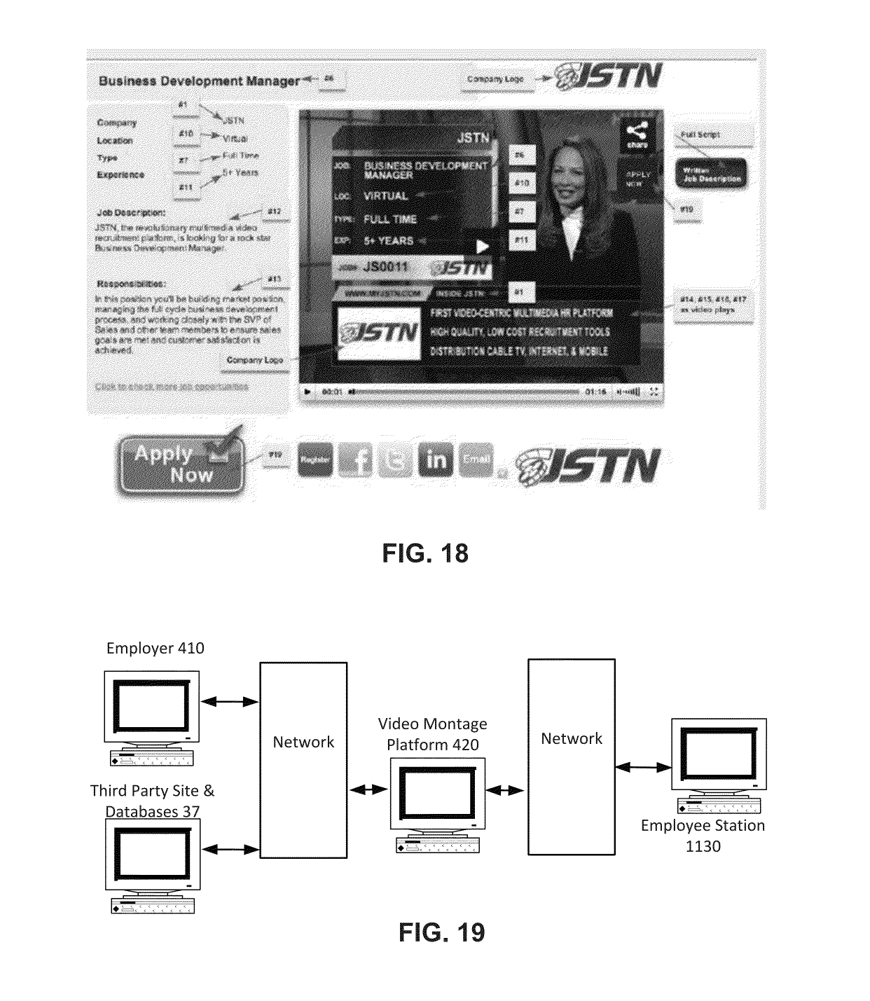

Another key part of the process includes the use of a Job Report Information Form sent to employers to help with the process of generating the text job opening 430 as shown at FIG. 4. In one embodiment, the firm is a .pdf format with scroll-down bars to help fill in different fields

| Field # | Text | Information Type |
|---|---|---|
| #1 | COMPANY NAME | TEXT |
| #2 | JOB REPORT LANGUAGE | TEXT |
| #3 | SUBSIDIARY STATUS | YES - NO |
| #4 | PARENT NAME | TEXT |
| #5 | LISTING ENTITY | PARENT - SUBSIDIARY |
| #6 | JOB TITLE | TEXT |
| #7 | POSITION TYPE | CHOICE BAR |
| | | a. Full time |
| | | b. Part time |
| | | c. Full and/or Part time |
| | | d. Independent Contractor |
| | | e. Intern |
| | | f. Contract for Hire |
| #8 | JOB CATEGORY | CHOICE BAR |
| #9 | OPENINGS AVAILABLE | CHOICE BAR |
| | | a. Single |
| | | b. Multiple |
| #10 | CITY/STATE/COUNTRY | TEXT |
| #11 | EXPERIENCE NECESSARY | TEXT |
| #12 | BRIEF JOB DESCRIPTION | TEXT (MAX. LIMIT) |
| #13 | BRIEF RESPONSIBILITIES | TEXT (MAX. LIMIT) |
| | DESCRIPTION | |
| #14 | INSIDE COMPANY | THREE BULLET POINTS |
| | | FOR VIDEO |
| | | INTEGRATION (MAX |
| | | LIMIT) |
| #15 | BENEFITS | THREE BULLET POINTS |
| | | FOR VIDEO |
| | | INTEGRATION (MAX. |
| | | LIMIT) |
| #16 | RESPONSIBILITIES | THREE BULLET POINTS |
| | | FOR VIDEO |
| | | INTEGRATION (MAX. |
| | | LIMIT) |
| #17 | QUALIFICATIONS | THREE BULLET POINTS |
| | | FOR VIDEO |
| | | INTEGRATION (MAX. |
| | | LIMIT) |
| #18 | FULL JOB DESCRIPTION | TEXT |
| #19 | JOB APPLY URL | |
| EXAMPLE | | SEE FIG. 18 |
| GIVEN | | |
| SCRIPT | | GENERATED BY |
| | | PLATFORM |
| | | (#440 FROM FIG. 4) |
| INTERNAL | | |
| USE SHEET | | |

The illustration at FIG. 18 in an effort to manage the process of generation of a Job Report, an employer 410 described at FIG. 4 will provide a text job opening 420 by filling in #1 to #13 in the table above. In some cases, elements #14 to #19 will be entered internally. The system will generate a script from the information found at #1 to #19 using proprietary technology and the graphic form. Many features of this intake sheet are novel.

In addition to capturing and automating the process, points #12 to #17 includes a formatting of a maximum number of characters is placed on the data entry. This allows for the generation of the graphic form 450 as shown at FIG. 4 without having to validate the formatting. The use of three bullet points at elements #14 to #17 allows a control of the script format in a default setting to help place the graphic form in the right place. For example, templates can be used to mine the data from the different elements #1 to #19. Generally, all of the fields entered will be used as part of the script created.

The use of these different elements as shown at FIG. 18 allows for a simple way to populate a video and generate at least the video overlay over the normal script.

In yet another embodiment, what is contemplated is the use of a simpler version of the Job Report, a video which incorporates most of the elements described above without the need for a prompter and an anchor in a recording. This “Montage Video” is designed from a template-type setup where animation is uploaded, along with other images from either databases (such as for example Youtube® or a corporate site of an employer. The script, instead of being sent to a prompter, is simply read as an audio file layered on an animated presentation. Tools like Photoshop® or After Effect® can serve to generate the Montage Video.

FIG. 19 illustrate the different computers or databases needed to help generate the Montage Video, the location where the video is done is shown as 420 connected via a network to either the employee station 1130 or the internet where the Montage Video will reside. The visual data, instead of being generated by the service provider can be taken from an Employer 410 or its website or borrowed with license from third party sites and databases 37.

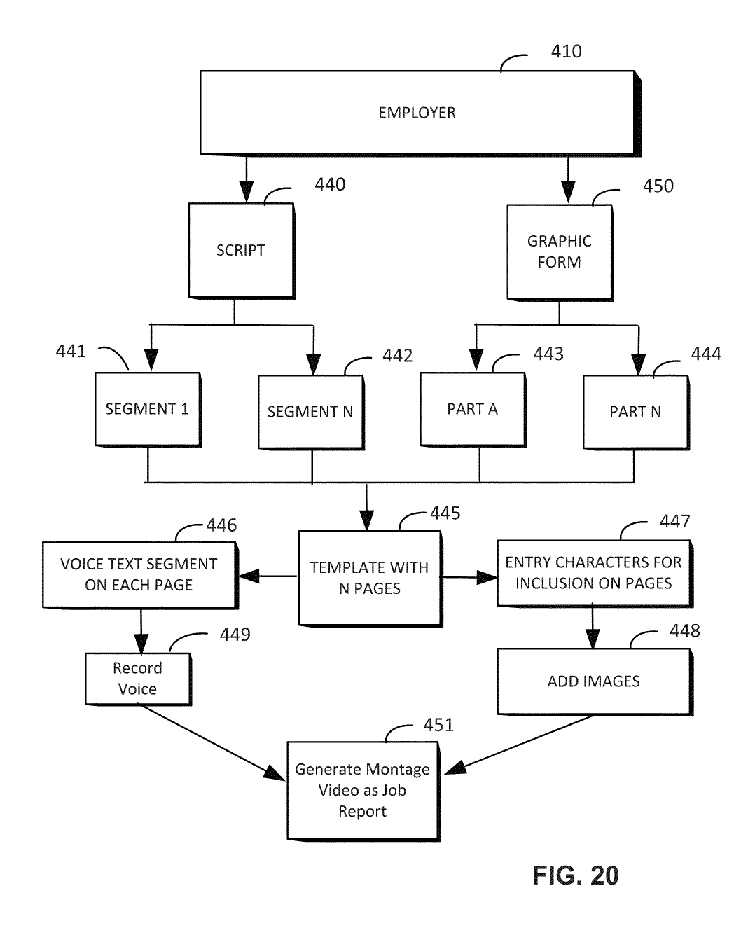

FIG. 20 illustrates how a template, for example using PowerPoint® software can be made to include multiple slides to ‘fill’ with data. Each slide page also includes a portion of the script 440 to be read in the audio recording device as the use, a portion of the graphic form and mounted on one or more images from the third party source. Much like the Job Report is generated using the process shown at FIG. 5, the Montage Video of a Job Report 451. The data from the employer 410 describing the job function of the job opening 430 is split into a script portion 440 and a graphic form portion 450. Instead of being simply sent to the character generator 510 and the teleprompter 520 as shown at FIG. 5, the information is broken into several N segments 441, 442, and into several parts A to N 443, 444. The data is then merged into a template 445 with the number of pages N needed to contain all of the script 440 and the graphic form 450.

The information is then merged into a single software utility and each character is merged into the pages of the template 447 and the voice is then read by a person 449 using each segment 446 associated with the page N. Once images are added 448 to the characters taken from one of multiple places, the information is then merged 451 into a single film format. The film plays like an animation with text and images appearing with different types of fade-in functions like an animation.

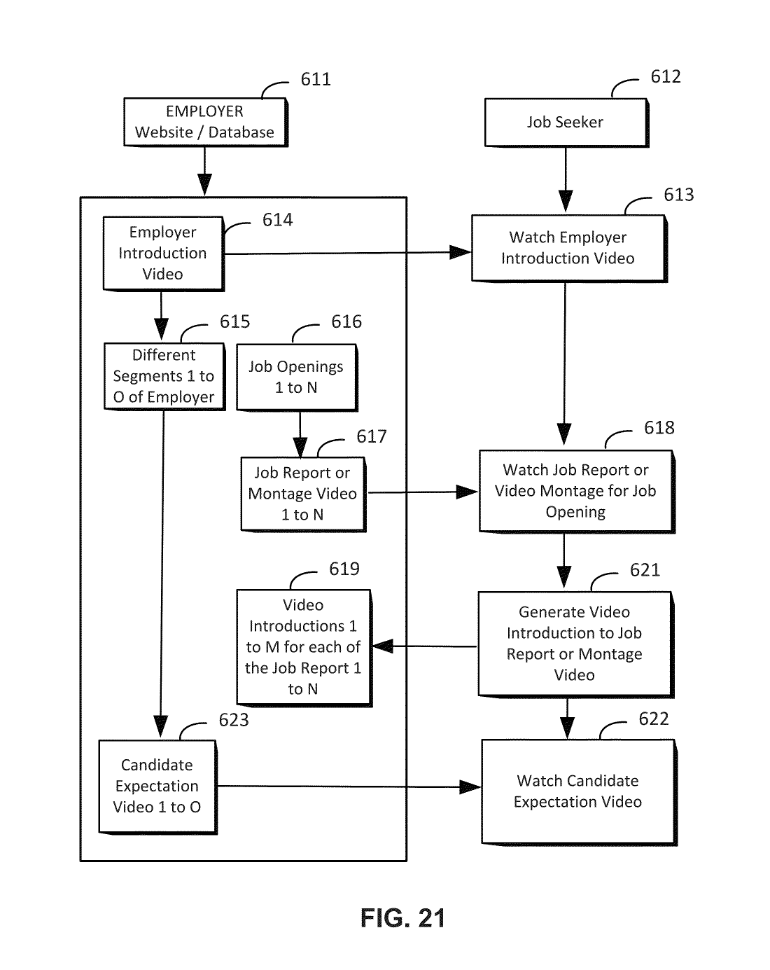

Finally, FIG. 21 illustrates the complete process of hiring a Job Seeker 612 by providing this person with multiple video tools to help enhance the process. The employer has a database 611 or a website portal on which the Job Seeker 612 can use his/her own HTML portal or browser connected to the internet, or use a local station located in a convenient location for the Employer (such as for example a standalone station) to watch either of (a) an employer introduction video 614, which describes generally the employer, (b) a Job Report or Montage Video 617 which describes generally (as described in greater detail above) a job opening to be answered by the Job Seeker 612, and (c) a Candidate Expectation Video 623 which is designed to describe the process linked with the hire of the potential candidate.

The Candidate Expectation Video 623 is designed to describe generally one of multiple different segments 615 of the employer. As shown at FIG. 21, the employer may have a number O of different business segments. For example, the Employer may have a different hiring process for lateral attorneys, summer associates, and staff attorneys. For each of these groups, a different Candidate Expectation Video 623 may be produced and associated with each of the Job Report or Montage Video 617 created.

The Candidate Expectation Video 623 is designed to offer visual and written information describing the internal hiring process at the Employer 611. This allows a potential Job Seeker 612 to set reasonable expectations as to when the Employer 611 will get back to the individual. For example, larger corporations may require three weeks before getting back to the Job Seeker 612. Failure to inform the Job Seeker 612 of this potential delay may result in the most employable candidates to believe erroneously that the Employer is not interested and will accept other opportunities. The Candidate Expectation Video 623 is produced by using the same technology as described above for either a Job Report or a Montage Video 617. The principle of offering a Candidate Expectation Video 623 to the Job Seeker 612.

As shown at FIG. 21, a Job Seeker 612 may use an HTML browser to view an employer introduction video 613, then watch an associated Job Report or Video Montage for a job opening of interest 618. As described above, the Job Seeker 612 may then generate a Video Introduction responsive to the Job Report or Montage Video 621. In a subsequent step, the method includes the Job Seeker 612 watching 622 a Candidate Expectation Video 623 available on the Employer Website 611.

That is shown is a system for generating a plurality of videos 614, 615, and 623 as shown at FIG. 21 or 1120, 1130, and 1170 at FIG. 11 related to the employment of a potential job seeker 612 at an employer 1140 at FIG. 11 and for managing the process of employment of the job seeker 612 by the employer 1140. This recruitment system comprises at least a server 1150 for storing an employer database 611 as shown at FIG. 21 on behalf of an employer with a plurality of job openings 616 accessible by a job seeker 612 via a communication network 1110 as shown at FIG. 11 by a plurality of job seekers 1120, 1130, and 1170 each using a job seeker device to allow the plurality of job seekers to engage in the process of employment.

The system also includes a platform 420 for generating at least a Job Report 630 or a Montage Video 451 as shown at FIG. 20 associated with at least a Job Opening 616, and at least a Candidate Expectation Video 623 associated with a different segment 615 in which the Job Report or the Montage Video is associated. The system also allows for the upload and storing from the platform 420 to the server 1150 of the Employer Introduction Video 614, the Job Report or the Montage Video 617, and the Candidate Expectation Video 623. The system also allows for the viewing by the job seeker at the job seeker device of the Job Report 618 before generating a Video Introduction 621 at the job seeker devices and uploading the Video Introduction to the server 619, and where the system allows for the viewing by the job seeker of the Candidate Expectation Video 622 at the job seeker device.

In another embodiment, the system includes the generation by the platform 420 of the Job Report or Montage Video by an employer upload 430 using an employer device a text-based job description relating to a job opening 616 to the server via the communication network link between the employer device and the server as shown at FIG. 11, where the server 1150 includes a multimedia requirement system as shown at FIG. 6 for the production of the Job Report or the Montage Video.

Also described is how the Job Report is produced by transforming the text-based job description using the platform into a script 440 and a graphic form 450, by inputting the script into a teleprompter to be read by an on air talent as shown at FIG. 6 and recorded using a camera as a first video, and by inputting the graphic form into a character generator also shown at FIG. 6 for producing a second video, by storing the first and second videos in a storage area network, and editing the first and second videos to produce with both the first and second videos the Job Report 630.

The Montage Video 451 as shown at FIG. 20 produced by transforming the text-based job description using the platform into the script 440 and the graphic 450 form both broken into several voice text segments 441, 442 and parts for insertion within a template 445 with multiple pages and by entry of characters 447 for inclusion on the multiple pages, and adding at least an image 448, and merging a recorded voice of each voice 449 text segments 446 into a Montage Video using the software 451.

The generation by the platform of the Candidate Expectation Video as shown at FIG. 21 includes at least information on a different segment of the Employer and an anticipated response time to an uploaded Video Introduction in response to the Job Report or the Montage Video by the Employer.

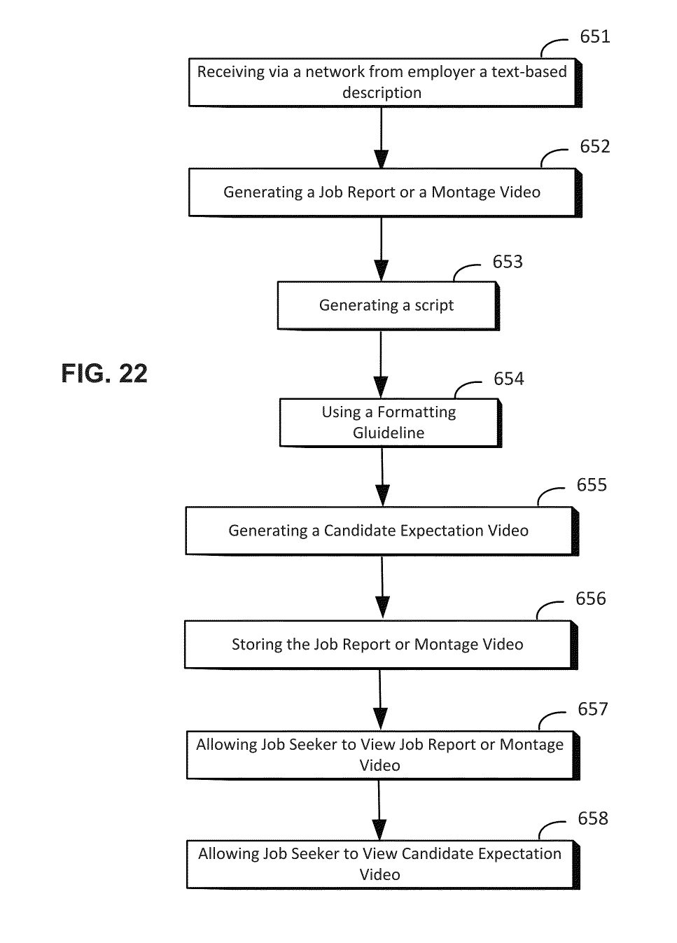

As shown at FIG. 21 by the arrows, what is also claimed is a method of optimizing the process of hiring of a job seeker using a system for generating a plurality of videos related to the employment of the job seeker, the method comprising the steps of receiving 651 as shown at FIG. 22 via a network from an employer at a platform a text-based job description associated with at least a job opening where the text-based job description includes at least a field having a maximum character limit and a field having a limited number of bullet points, generating 652 at the platform using the text-based job description at least a Job Report or a Montage Video, where the generation includes sub-steps of generating a script 653 to be read either by an on-air talent in a prompter or to be read by a narrator reading a segment of the script associated with a page of a template, and where the Job Report or Montage Video using 654 as a formatting guideline the maximum character limit or the limited number of bullet point.

The method then includes the step of generating 655 at the platform using employer information a Candidate Expectation Video including at least information on a segment of the Employer and an anticipated response time to an uploaded Video Introduction in response to the Job Report or the Montage Video and then storing 656 by the platform on a server in an employer database the Job Report or the Montage Video for uploading by a remote job seeker using a job seeker device and allowing 657 the job seeker to view the Job Report or the Montage Video, uploading and storing on the server in the employer database a Video Introduction produced by the job seeker based on the Job Report or the Montage Video, and allowing 658 the job seeker to view the Candidate Expectation Video to receive at least the information on the segment of the employer and the anticipated response time by the employer to the Video Introduction.

In a further step, what is contemplated is the step of generating at the platform an Employer Introduction Video, and allowing the job seeker to view the Employer Instruction Video before the step of allowing the job seeker to view the Job Report of the Montage Video.

Exemplary embodiments are described above. It is, however, expressly noted that these exemplary embodiments are not limiting, but rather the intention is that additions and modifications to what is expressly described herein also are included within the scope of the present implementation. Moreover, it is to be understood that the features of the various embodiments described herein are not mutually exclusive and can exist in various combinations and permutations, even if such combinations or permutations are not made express herein, without departing from the spirit and scope of the present implementation.

Since certain changes may be made without departing from the scope of the present implementation, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present implementation and that the illustrations contained herein are singular examples of a multitude of possible depictions of the present implementation.

What is claimed is:

1. A system for generating a plurality of videos related to the employment of a potential Job Seeker at an Employer and for managing the process of employment of the Job Seeker by the Employer, the recruitment system comprising:
a server for storing an employer database on behalf of an employer with a plurality of job openings accessible by a job seeker via a communication network by a plurality of job seekers each using a job seeker device to allow the plurality of job seekers to engage in the process of employment, and a platform for generating at least a Job Report or a Montage Video associated with at least a Job Opening, and at least a Candidate Expectation Video associated with a different segment in which the Job Report or the Montage Video is associated,
wherein the system allows for the upload and storing from the platform to the server of the Job Report or the Montage Video, and the Candidate Expectation Video,
wherein the system allows for the viewing by the job seeker at the job seeker device of the Job Report before generating a Video Introduction at the job seeker devices and uploading the Video Introduction to the server, and
wherein the system allows for the viewing by the job seeker of the Candidate Expectation Video at the job seeker device.

2. The system of claim 1, wherein the generation by the platform of the Job Report or Montage Video is created by an employer upload using an employer device a text-based job description relating to a job opening to the server via the communication network link between the employer device and the server, wherein the server includes a multimedia requirement system for the production of the Job Report or the Montage Video, the Job Report produced by transforming the text-based job description using the platform into a script and a graphic form, by inputting the script into a teleprompter to be read by an on air talent and recorded using a camera as a first video, and by inputting the graphic form into a character generator for producing a second video, by storing the first and second videos in a storage area network, and editing the first and second videos to produce with both the first and second videos the Job Report, and the Montage Video produced by transforming the text-based job description using the platform into the script and the graphic form both broken into several voice text segments and parts for insertion within a template with multiple pages and by entry of characters for inclusion on the multiple pages, and adding at least an image, and merging a recorded voice of each voice text segments into a Montage Video using the software.

3. The system of claim 2, wherein the generation by the platform of the Candidate Expectation Video includes at least information on a different segment of the Employer and an anticipated response time to an uploaded Video Introduction in response to the Job Report or the Montage Video by the Employer.

4. A system for generating a plurality of videos related to the employment of a potential Job Seeker at an Employer and for managing the process of employment of the Job Seeker by the Employer, the recruitment system comprising:
a server for storing an employer database on behalf of an employer with a plurality of job openings accessible by a job seeker via a communication network by a plurality of job seekers each using a job seeker device to allow the plurality of job seekers to engage in the process of employment, and
a platform for generating at least an Employer Introduction Video, a Job Report or a Montage Video associated with at least a Job Opening, and at least a Candidate Expectation Video associated with a different segment in which the Job Report or the Montage Video is associated,
wherein the system allows for the upload and storing from the platform to the server of the Employer Introduction Video, the Job Report or the Montage Video, and the Candidate Expectation Video,
wherein the system allows for the viewing by the job seeker at the job seeker device of the Employer Introduction Video, and the Job Report before generating a Video Introduction at the job seeker devices and uploading the Video Introduction to the server, and
wherein the system allows for the viewing by the job seeker of the Candidate Expectation Video at the job seeker device.

5. The system of claim 1, wherein the generation by the platform of the Job Report or Montage Video is created by an employer upload using an employer device a text-based job description relating to a job opening to the server via the communication network link between the employer device and the server, wherein the server includes a multimedia requirement system for the production of the Job Report or the Montage Video produced, the Job Report produced by transforming the text-based job description using the platform into a script and a graphic form, by inputting the script into a teleprompter to be read by an on air talent and recorded using a camera as a first video, and by inputting the graphic form into a character generator for producing a second video, by storing the first and second videos in a storage area network, and editing the first and second videos to produce with both the first and second videos the Job Report, and the Montage Video produced by transforming the text-based job description using the platform into the script and the graphic form both broken into several voice text segments and parts for insertion within a template with multiple pages and by entry of characters for inclusion on the multiple pages, and adding at least an image, and merging a recorded voice of each voice text segments into a Montage Video using the software.

6. The system of claim 2, wherein the generation by the platform of the Candidate Expectation Video includes at least information on a different segment of the Employer and an anticipated response time to an uploaded Video Introduction in response to the Job Report or the Montage Video by the Employer.

7. A method of optimizing the process of hiring of a job seeker using a system for generating a plurality of videos related to the employment of the job seeker, the method comprising the steps of:
receiving via a network from an employer at a platform a text-based job description associated with at least a job opening, wherein the text-based job description includes at least a field having a maximum character limit and a field having a limited number of bullet points,
generating at the platform using the text-based job description at least a Job Report or a Montage Video, wherein the generation includes sub-steps of generating a script to be read either by an on-air talent in a prompter or to be read by a narrator reading a segment of the script associated with a page of a template, and wherein the Job Report or Montage Video uses as a formatting guideline the maximum character limit or the limited number of bullet point,
generating at the platform using employer information a Candidate Expectation Video including at least information on a segment of the Employer and an anticipated response time to an uploaded Video Introduction in response to the Job Report or the Montage Video,
storing by the platform on a server in an employer database the Job Report or the Montage Video for uploading by a remote job seeker using a job seeker device,
allowing the job seeker to view the Job Report or the Montage Video,
uploading and storing on the server in the employer database a Video Introduction produced by the job seeker based on the Job Report or the Montage Video, and
allowing the job seeker to view the Candidate Expectation Video to receive at least the information on the segment of the employer and the anticipated response time by the employer to the Video Introduction.

8. The method of claim 7, further comprising the step of generating at the platform an Employer Introduction Video, and allowing the job seeker to view the Employer Instruction Video before the step of allowing the job seeker to view the Job Report of the Montage Video.
